(19) United States
(12) Patent Application Publication
(10) Pub. No.: US 2012/0269467 A1
(43) Pub. Date: Oct. 25, 2012

(54) Pouch Bag, Closure Device and Method of Manufacture of a Bag

(76) Inventor: Paul Bjerring, Horning (DK)

(21) Appl. No.: 13/510,993

(22) PCT Filed: Nov. 18, 2010
(86) PCT No.: PCT/DK10/00150

§ 371 Date: May 21, 2012

(30) Foreign Application Priority Data
Nov. 19, 2009 (DK) PA 2009 01224

(51) Int. Cl. B65D 30/14; B65D 33/00; B31B 1/00

(52) U.S. Cl. 383/114; 493/267; 383/105

(57) ABSTRACT

The invention presents a flexible bag of the pouch type, made from a single or multilayer flexible packaging material, where said bag comprises a first and a second side panel and a bottom panel, where said side panels has a top edge, two side edges and a bottom limitation, where the first side panels' bottom limitation converges into a spout shaped triangle said triangle having an apex, where the distance between the top edge and the apex of the spout shaped triangle is substantially larger than the distance between the second side panels top edge and bottom limitation, and where said spout near the apex optionally is provided with means for detaching said apex from the bag.

### FIELD OF THE INVENTION

The present invention is directed to a dispenser bag and a closure member for said bag as well as a method of manufacturing said bag.

### BACKGROUND OF THE INVENTION

In the art there are numerous examples of liquids stored, transported and dispensed from flexible dispenser bags.

In EP0162417 is disclosed a disposable package made from a flexible material, where a valve device is arranged in what will be the bottom as the bag is positioned in the dispenser. The dispenser comprises means for activating the valve and dispenses a dose of the bags' contents. Similar arrangements are known from U.S. Pat. No. 5,649,643, U.S. Pat. No. 5,806,717, U.S. Pat. No. 6,003,733, U.S. Pat. No. 6,082,590, U.S. Pat. No. 6,127,009, US2005039819, W020070346.

A dispenser/bag system is also disclosed in U.S. Pat. No. 6,273,297. In one embodiment no valve is arranged in the bag, such that the bag is only made from flexible material, which provides for a relatively cheap and reliable manufacturing process. The bag is provided with a snout which is where the material in the bag is to be dispensed. The dispenser is provided with means for opening or closing the snout. The means includes first and second members which are biased towards each other. The means may be provided with mutual corresponding means which effectively closes the snout. Furthermore means are provided for forcing the material in the bag towards and out through the snout, in the shape of a weight or the like.

US2002/0186900 describes a flexible bag made from a flexible film material, where the material has been provided with cuts and score lines prior to being formed. This requires high precision when forming the bag in that cuts etc has to be perfectly aligned.

During manufacture of these types of bags the material is feed at approx. 2-400 m material per minute. It requires very high precision adjusting the machinery in order to align cuts and score lines appropriately. The bag is made for aesthetic appearances with an asymmetric bottom and side panels such that the bag will stand out from other products on the shelves. Due to the design it may give the appearance of a skull.

Common for all these flexible bags is the fact that they to a certain degree rely on the dispenser or features of the dispenser in order to dispense the flowable material. Furthermore as there is an interaction between the flexible bag and the dispenser, it is a requirement that the part of the dispenser coming into contact with the flowable liquid shall be cleaned, rinsed and maintained with regular intervals. This is necessary in order to safeguard proper functioning and maintain a high hygienic standard.

### SUMMARY OF THE INVENTION

It is therefore an object of the present invention to provide a flexible bag which alleviates the problems mentioned above with the prior art, and provides additional advantages.

The invention consequently presents a flexible bag of the pouch type, made from a single or multilayer flexible packaging material, where said bag comprises a first and a second side panel and a bottom panel, where said side panels has a top edge, two side edges and a bottom limitation, where the first side panels' bottom limitation converges into a spout shaped triangle said triangle having an apex, where the distance between the top edge and the apex of the spout shaped triangle is substantially larger than the distance between the second side panels top edge and bottom limitation, and where said spout near the apex optionally is provided with means for detaching said apex from the bag.

In this context it is to be noted that although in some embodiments the different panels of the bag are described as separate panels, they may in fact be connected, or be separate, or one or more panels may be connected/continuous. The skilled person will readily understand the advantages, and apply the appropriate configuration depending on the available manufacturing equipment.

By providing an asymmetric bottom, the bottom will have a slope towards the spout. When the bag for example is suspended in a dispenser, as will be discussed below, the bottom will be sloping sufficiently in order to urge the liquid or flowable material contained in the bag towards the spout. Furthermore as no welds or seams are present in the bottom surface of the bag, there will be no resistance to the flow, nor will there be any waste due to the irregularities which are normally present in seams or welds. It is therefore possible to substantially completely empty the bag.

In a further preferred embodiment the spout has a substantially cylindrical and/or tube-shaped extension. In this manner it is assured that the material in the bag will exit the bag as a controlled jet, which jet it is possible to control/direct as desired.

In a further preferred embodiment the flexible bag is made from a flexible material which is weldable on one side only, and that this weldable side of the material during manufacture of the bag is the inside of said bag.

This embodiment provides for a very simple and fast manufacturing process, which is claimed in an independent method claim.

The invention is therefore also directed at a method of manufacturing a flexible bag from a flexible single or multilayered film material, where said bag has an asymmetric bottom where:
a. said material is shaped into a U-shaped cross section, such that two side portions and a bottom portion is created;
b. a former is introduced into the bottom portion of the U creating a W shape;
c. where the former is asymmetric, such that one V of the W is larger than the other V;
d. two seals are created at a mutual distance along the material, where said seals define the sides of the bag.

The fact that the material is weldable on one side only, makes it possible to weld in one process, whereby the two V's of the W are welded at the same time without the two V's being welded together.

In JP 7-132943 is used a former in order to create a standing pouch bag, where the former creates a W-like folding shape, before the bag is welded. The method in JP 7-132943 is used on a horizontal form, fill and seal machine.

By making the former asymmetric, one of the V's is substantially longer than the other. By furthermore providing two more welds at an oblique angle to the side edges a spout is formed in the longer of the V's. These last welds originates approximately in the middle of the bottom limitation of the longest V, and converges towards the side edges at a distance up each side edge from the bottom limitations. It is not necessary that the last oblique welds are only present in the longest V, but if the oblique welds also affect the shorter V, this will lead to a lesser volume of the entire bag.

In another preferred embodiment of the invention the bag pouch may also be manufactured by alternative methods, for example, by providing separate side and bottom panels, and welding these together along superposed side edges and bottom limitations. Such a process is suggested in JP 2007-227968. Another method usuable to manufacture the novel and inventive pouch bag may be as suggested in JP 2001-206307 and JP 11-152104. These prior art methods describes methods for manufacturing standing pouch bags in line on vertical form fill and seal (VFFS) machines. By replacing the welding cams by cams which are offset and displaced (horizontally) it is possible to modify the VFFS machine, in order to create the asymmetric bottom. There are however other parts of the machine which also have to be adapted in order to feed the flexible material in an asymmetric way to the former tools. The collection tools receiving the finished bag also needs to be modified. These modifications are outside the scope of the present invention, and will be evident to the skilled person when having understood the present invention.

Consequently in a further advantageous embodiment of the invention of the flexible bag the second side panel is continuous with the bottom panel and the first side panel, and where said first and second side panels are connected by welds along their side edges, where the bottom limitations are welded at oblique angles to the side edges.

One of the principal objects of the present invention is to provide a bag for dispensing liquids and other flowable materials. It is therefore important to provide opening means in the spout provided due to the asymmetric shape of the bag.

In a still further preferred embodiment of the invention the means for detaching the apex is any one or a combination of: a die cut I- and/or “V” shape outside and partly into the welds at said apex and as a further preferred embodiment a laser scoring and/or a micro-perforated line and/or a score line and /or mechanical weakening by embossing partly through the material layers across said apex.

In a further preferred embodiment of the invention means for opening and closing the spout is provided, where said means are arranged further from the apex than the means for detaching said apex from the bag, and where said means for opening and closing may be arranged inside the bag, may be integral with said flexible material, or may be arranged on the exterior side of the bag.

The arrangement of opening/closing means in the bag facilitates the use of the bag without a dispenser. For a number of products, such as for example windshield wiper fluid, fuels, fruit juices, milk, engine oil and many more, it is often desirable to empty the package in one go or perhaps in a few portions. By providing an inexpensive package, it is feasible to create/provide smaller amount packages which are intended for one time use only. For some substances they keep poorly, i.e. loose some of their properties over time, or for space considerations it is not desirable for the consumer to store left overs etc.

The means may be incorporated into the spout of the bag, for example in the shape of reinforced/folded sections near the spouts opening, which when no pressure is applied to the bag, will not allow material to be dispensed. Alternatively the means may be attached to the outside, for example in the shape of flexible clip members arranged across the spout. By flexing the members, material is allowed to be dispensed from the bag.

The means, both the means arranged inside the bag, integral with said flexible material, or the means arranged on the exterior side of the bag, may also be pressure activated, such that as a user desiring to dispense material from the bag, a pressure is applied to the pouch bag, whereby the opening/closing means are forced open by the increased pressure in the material.

An example of means for dispensing material from the bag without a dispenser per se, is the subject of a further advantageous embodiment of the invention wherein means for opening and closing the bag (also referred to as a clip) comprises two substantially identical halves, where the snout of the bag is fitted on the inner surfaces of the halves. At the outlet opening of the clip, is arranged a jaw—closing lip, where one or more ridges arranged in one clip half and facing the other half in the closed non activated position, interfits tightly in corresponding grooves in the opposite half. Part ways from the outlet opening the halves are flared away from each other. The two halves are connected in the sides by plastic material creating a biased hinge, urging the jaw to remain shut. By furthermore arching the flared ends of the clip, a channel is created even when the flared ends are squeezed together in order to open the jaw. In this position the material will be able to flow freely from the bag.

Due to the resiliency of the biased hinge, the jaws will close again, when the flared opposite ends of the clip are released again.

In a further preferred embodiment of the invention a valve with an integrated tool is glued, sealed or welded to the spout. When activated the tool in said valve penetrates, cuts or in any other manner creates an opening in the flexible packaging material in order to allow the material to be dispensed when the valve is activated.

In a further advantageous embodiment said first and second panels continues below the bottom limitations of the interior of the bag, where said first and second panels' continuations are provided with stiffening welds, and the lower edges of said first and second panels are in a common plane.

With this configuration the bottom construction will provide a relatively stable base, such that the bag will be able to stand by itself. Especially with bags having a certain volume, such as 1 to approx 5 litres, using a flexible film material having a thickness in the range 80 to 150 μm, a very stable construction is achieved.

It is also contemplated by combining the various embodiments to have a bag with a relatively stable base, as discussed here above, and further provide an extra panel in the top section, whereby the side panels will form an almost cylindrical bag. In this configuration the volume is increased inside the bag, as compared to some of the other embodiments suggested herein.

The flexible bag where the spout is at least partly integrated in the continuation is disclosed in a still further advantageous embodiment.

The alternative is to provide a spout extending from the bottom section. In practice this spout is folded back on the bag itself an attached either to the bottom panel or the front side of the bag by means of a sticker or other adhesive means. However by integrating the spout in the bottom section, the increased stiffness of this section is utilised, and at the same time the user-friendliness is increased as when desiring to discharge material, it is not necessary to release and point the spout.

In a still further embodiment of the invention the means for opening and closing said spout is arranged on the exterior of the spout, where said means for closing said spout comprises two substantially identical mirror image parts, where each part has a front plate and a back plate, where the front and back plates are contiguous, and where a closing lip is arranged along at least a part of the front plate, where said two parts are connected by a bridge member along a section of each side of the two parts, and where the spout of the bag may be accommodated between the two parts, and between the bridge parts along either side of the means for closing, and between the closing lips, and where the front plate is arranged at an angle relative to the back plate, such that as the back plates are forced towards each other the front plates will separate and allow material to pass through the spout, and further where biasing means may be provided urging the front plates together.

In a still further embodiment of the invention directed at the bag per se the first or second side panel is provided with an extension at said first or second side panels top edge, where said extension is continuous with said first or second side panel, which extension is folded down between said first and second side panels, and welded along the side edges. The extension of the side panel from the top edge creates a lid, i.e. a top panel whereby the body of the bag becomes substantially cylindrical when filled with a material, whereby when the bag is used in a dispenser, the effective volume inside the dispenser is used most economically. The embodiments of the invention not having the top panel will have a triangular-like cross section, see detailed description below relating to various embodiments, whereby, when arranged in a cylindrical dispenser the bag will leave an empty volume in the dispenser.

### DESCRIPTION OF FIGURES

The invention will now be explained with reference to the accompanying drawing, wherein

FIGS. 1 to 7 illustrates various details of a bag according to the invention;

FIGS. 8a to 12 illustrates various stages in the manufacture of a bag according to the invention;

FIGS. 13 to 18 illustrates various details of the spout of the bag, and dispensation control means;

FIGS. 19 to 24 illustrates various means for applying pressure to the bag in the dispenser.

### DETAILED DESCRIPTION OF A PREFERRED EMBODIMENT

Throughout the description below the same features will be designated by the same reference numbers.

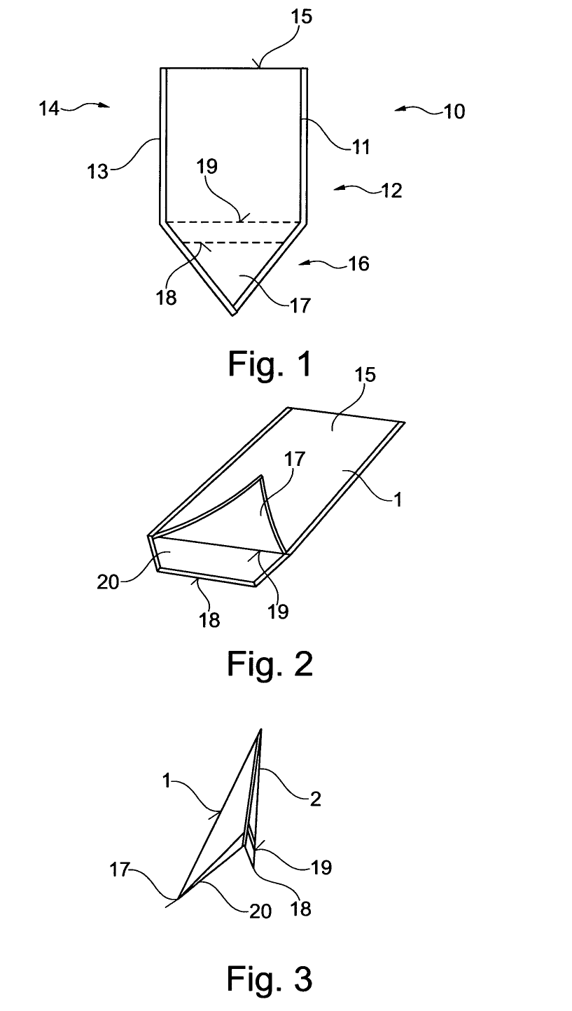

In FIG. 1 is illustrated the front face of an embodiment of a bag according to the invention. The bag 10 is made from a first side panel 1 which by means of welds 11,13 along the side edges 12,14 is connected to a second side panel 2 (see FIG. 3). The side panels, in this embodiment both the first and second side panels further has top edges 15, 15′. The first side panel 1 has a bottom limitation 16 in the shape of a triangle which has an apex 17. Later the apex will also be referred to as the snout, as this is the feature which makes the asymmetric bag suitable for dispensing material.

The dashed line 18 illustrates the bottom limitation of the second side panel 2, whereas the second dashed line 19, indicate the fold in the bottom in the bags collapsed configuration.

The design of the snout 17 is possible within wide design options, due to the fact that by changing the welding cams on the machine use to manufacture the bag, almost any snout design is achievable. For most applications a linear triangle shaping the apex 17, possibly with an extension of two parallel side edges will be desired.

For the dispensation of some materials, it is desirable to provide special properties in the snout. For example for the dispensation of some materials it is desirable to be able to create a jet of mist particles, which may be the case for disinfectants, lotions and the like. For this purpose the weld defining the outlet of the snout 17 will create small nozzle-like apertures. In other instances it is desirable to dispense a small portion of the material, for example with soap, moisturizers, lotions and the like. Here the snout 17 will define an outlet channel, through which the material may pass more or less unhindered.

It is also possible to arrange a tube or other member between the two material sheets, i.e. the first and second side panels, in the apex region, whereby special outlet means may be provided. This is usually achieved by arranging the outlet means on a thin film. For example, if it is desirable to have a short length of plastic tube arranged in the outlet, short lengths of tube are arranged on a separate film, with a mutual distance between the short length of tube corresponding to the mutual distances between the apex' on the bag production line. During manufacture the thin film with the tube sections is fed in between the first and second side panels. During the welding process the thin film with the tube section will be fixed in the correct position relative to the outlet. In this manner the bag is provided with a tube in the outlet. Naturally other parts having various properties suitable for use with the bag, and suitable to be applied in a similar manner are usuable within this concept.

In FIG. 2 the same bag 10 is illustrated where the triangle bottom limitation 16 with the apex 17 of the first side panel 1, is lifted in order to illustrate the fold 19 of the bottom panel 20.

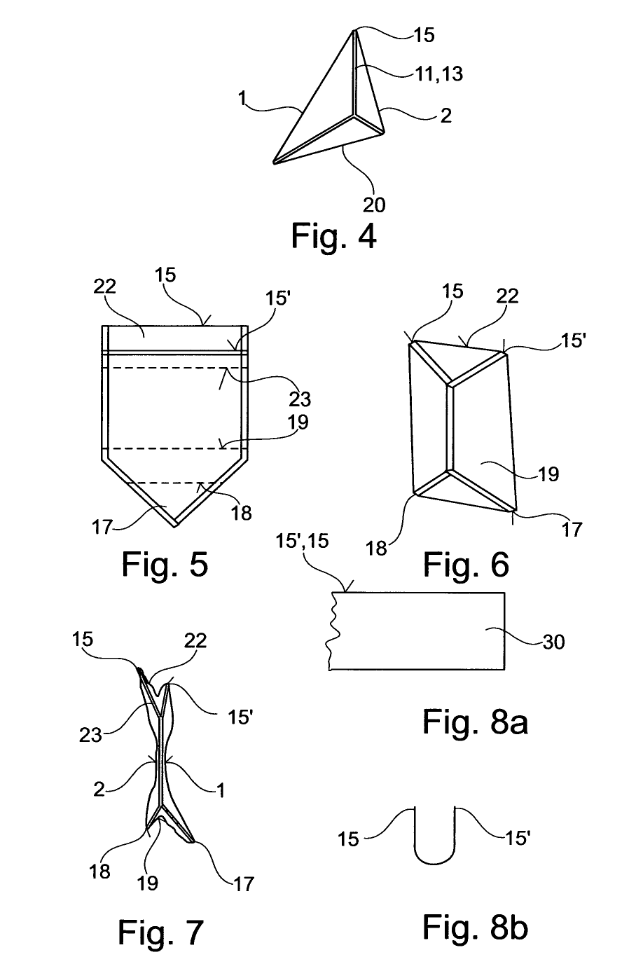

FIG. 3 illustrates the bag 10 seen from the side. In FIG. 4, the same bag 10 has been slightly inflated, for example by filling a material inside the bag. In the following description reference will be made to material, referring to any substance, preferably liquid which is to be contained inside the inventive and novel bag 10 according to the invention. By filling the bag the first side panel 1, will be urged towards the left in the illustration. The second side panel 2 will in the same manner be urged towards the left in the figure. At the same time the bottom 20 will be extended between the bottom limitations 16,18 of the first and second side panels 1,2.

Another embodiment of the invention is illustrated in FIGS. 5 to 7. The bottom construction is identical to the construction described above with reference to FIGS. 1 to 4. An extension panel 22 is provided either along the top edge 15,15′ of the first or second side panels 1,2. This extension panel 22 is folded down (see FIGS. 5 and 7) having a lower folding line 23—in FIG. 5 illustrated by the dashed line 23.

As the bag is filled with material it will attain the shape illustrated in FIG. 6, by extending the panel 22. In this embodiment the bag has a larger volume than the bag illustrated with reference to FIGS. 1 to 4, with the same ground area and height. When placed inside the housing of a dispenser, it is therefore possible to have a larger volume of material. Usually dispenser housings are cylindrical, thereby able to accommodate the bag as illustrated With reference to FIGS. 5 to 7.

In FIGS. 8a to 10d is illustrated a preferred manner of manufacturing a pouch bag according to the invention.

A flexible packaging material 30 is unwound from a roll of material (not illustrated). By passing the flexible material 30 through for example a set of parallel rollers, the flexible material 30 is given a U-shape as illustrated in FIG. 8b which is a cross section through the flexible material in FIG. 8a.

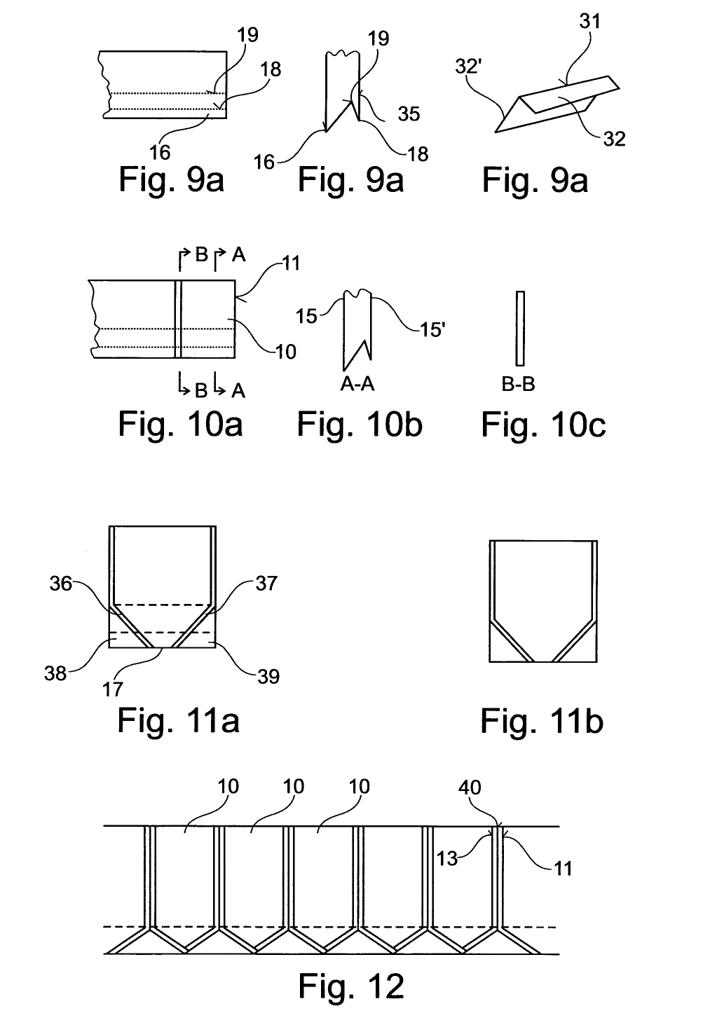

The flexible material 30 is passed over a former 31 schematically illustrated in FIG. 9c. The two sides 32,32′ have different widths, whereby the asymmetric “W” 35, illustrated in cross section in FIG. 9b is created. The first “V” has a bottom limitation 16 which is further distanced from the top edge 15, the the second “V”'s bottom limitation 18 relative to the top edge 15′.

In FIG. 10a the flexible material 30 is further provided with welds 11,13, thereby delimiting a bag 10, such that only the top edges 15,15′ are not welded together, thereby leaving an opening for filling material into the bag 10.

In FIG. 10 b section A-A is illustrated where it is evident that the top edges 15,15a are not connected, leaving a filling opening.

FIG. 10c illustrates a section B-B through a weld, where it is evident that the two flexible material layers are fused into a single unit.

In FIGS. 11a and 11b are illustrated the further step of providing oblique welds 36,37, thereby forming the triangular shape of the bottom limitation 16, and thereby the apex 17, which doubles as a snout. In FIG. 11b the surplus material 38,39 has been removed, whereby the bag as described with reference to FIGS. 1 to 4 is provided.

The bags 10, may also be manufactured without detaching/separating the bags, thereby providing an array of interconnected bags 10, as illustrated in FIG. 12. Separating each bag is two welds 11,13 and a perforation or score line 40, facilitating detachment of the single bags. Especially for some types of automatic filling machinery it is advantageous to provide the bags 10 on reels for detachment either before, during or after the filling process.

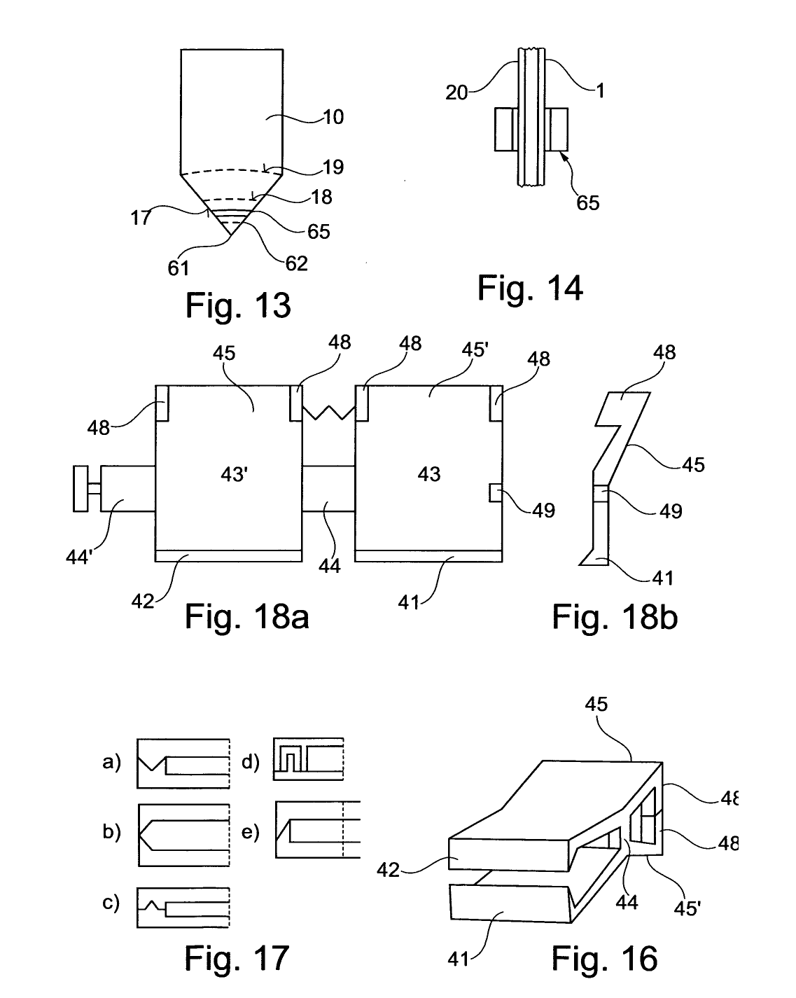

Turning to FIGS. 13 and 14 a further opening/closing mechanism is schematically illustrated. The bag 10, being more or less identical to the bags described above is provided with an exterior opening/closing device 65, arranged near or in the apex 17. Between the opening/closing device 65 and the tip of the apex, a perforation or scoring line 62 is provided, serving to allow the snip 61 being detached from the bag 10.

The opening/closing device is adhesively or otherwise fastened to the exterior of the bag. The opening/closing device comprises a double material layer strip construction where the material characteristics of the layers is such that the material strip will naturally bend due to the characteristics of the strip achieved by laminating in a curved position two or more layers of polymer . By bonding the material strip 65 to the surface of the bag 10 and including it in the weld along the side edges 11,13, the material strip 65 will close the bags snout 17. By exerting a force like described above (see arrows 60 in FIG. 16) the material strips will deform and provide an opening in the snout.

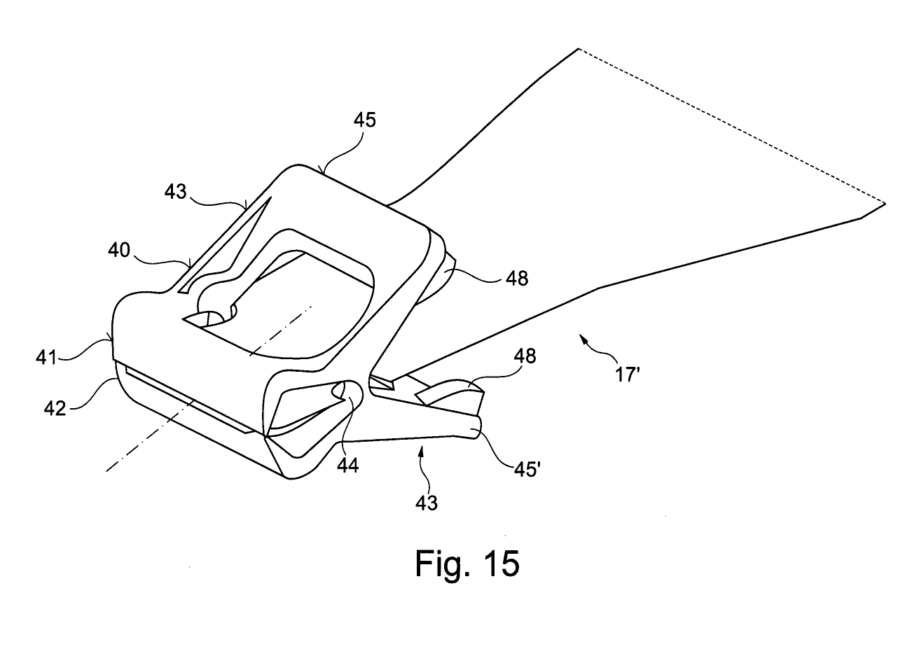

In FIG. 15 through 18 are illustrated various views and embodiments of a clip, i.e. means for opening and closing the snout/spout of the bag, described above.

In FIG. 15 the clip 40 is illustrated in its closed position. In this embodiment the bag 10 is provided with a tube shaped spout/extension 17′. The tip of the spout 17′ is arranged between the jaws 41,42 of the clip 40, such that as the jaws 41,42 are urged towards each other the will squeeze the film material from which the bag is made together and effectively close the bag.

The clip is made from two mirror image halves 43, which are connected by a bridge member 44. During injection moulding of the clip, the clip is shaped such that a biasing force is induced in the construction, whereby the two jaws 41,42 are urged together. The ends 45,45′ of the clip opposite to the jaws 41,42 are flared away from each other. In this manner as the flared ends 45, 45′ are pushed towards each other, the jaws 41,42 will separate and open the bags spout. In order to avoid the ends 45, 45′ being squeezed completely together projections 48 are provided making sure that the flared ends 45, 45′ can only be closed to a certain degree, still allowing material in the bag to flow through the open spout.

A corresponding configuration of a clip is illustrated in FIG. 16. In this schematic illustration the clip is open, i.e. the flared ends 45, 45′ are squeezed together, opening the jaws 41, 42. The projections 48 hinders the flared ends 45, 45′ squeezing the spout, and cutting off the flow of material through the spout.

In FIG. 17 a) through e) are illustrated various configurations of the ends of the jaws. The ends are configured to compliment each other in order to assure a completely closing off of the spout.

FIGS. 18a and 18b illustrate a one-piece clip construction. The clip 40 is injection moulded as a substantially flat piece as illustrated in a plane view in FIG. 18a. A cross-section through the flat piece is depicted in FIG. 18b.

By folding the flat piece such that one half 43 becomes superposed the other half 43′, the free bridge portion 44′ is inserted into the aperture 49. In this position the clip will look substantially as depicted in FIG. 16.

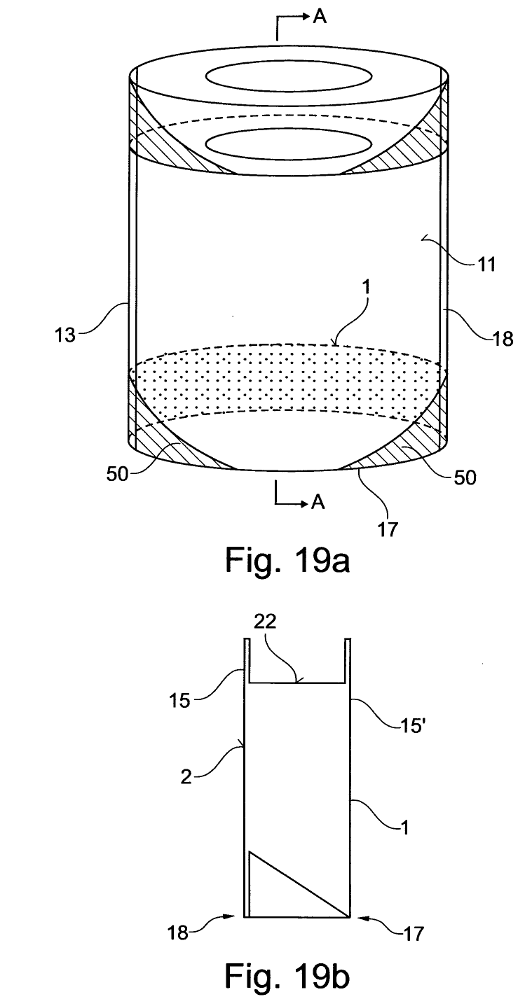

Finally in FIGS. 19a and 19b is illustrated a preferred self-standing embodiment of a bag according to the invention. In FIG. 19a an isometric representation is illustrated, and in FIG. 19b a cross section A-A substantially vertically through the middle of the bag is illustrated.

The side panels 1,2 have substantially the same length outside of the bag, whereas the welds 18,17 provides for the asymmetric bottom. A further top panel 22 is provided, whereby the volume of the bag is greatly increased. Generally the bag is in principle identical to the bag described above with reference to FIGS. 5 and 6, but is also provided with extended bottom sections which facilitates that the bag may stand by itself. The welded areas 50 provides a firm basis for the bag structure.

Above the shape of the bag as well as a method of manufacturing said bag has been described with reference to schematic embodiments. It is naturally possible to achieve the advantages of the invention with other bag shapes, sizes, manufacturing methods etc, as it is possible to provide various modifications to the dispenser, for example automize dispensation, activate by optical means etc without departing from the inventive principles of the invention.

1. A Flexible bag of the pouch type, made from a single or multilayer flexible packaging material, where said bag comprises a first and a second side panel and a bottom panel, where said side panels has a top edge, two side edges and a bottom limitation, where the first side panels' bottom limitation converges into a spout said spout having an apex, where the distance between the top edge and the apex of the spout is substantially larger than the distance between the second side panels top edge and bottom limitation, and where said spout near the apex optionally is provided with means for detaching said apex from the bag, or the spout is provided with an opening.

2. The flexible bag according to claim 1 wherein the spout has a substantially cylindrical and/or tube-shaped extension.

3. The flexible bag according to claim 1, wherein the second side panel is continuous with the bottom panel and the first side panel, and where said first and second side panels are connected by welds along their side edges, where the bottom limitations are welded at an oblique angle to the side edges.

4. The flexible bag according to claim 1 further provided with means for opening and closing said spout, and where said means for opening and closing may be arranged inside the bag, may be integral with said flexible material, or may be arranged on the exterior side of the bag.

5. The flexible bag according to claim 1 where the second side panel is provided with an extension at said second side panels top edge, where said extension is continuous with said second side panel, which extension is folded down between said first and second side panels, and welded along the side edges.

6. The flexible bag according to claim 1, wherein said first and second panels continues below the bottom limitations of the interior of the bag, where said first and second panels' continuations are provided with stiffening welds, and the lower edges of said first and second panels are in a common plane.

7. The flexible bag according to claim 6, wherein the spout is at least partly integrated in the continuation.

8. The flexible bag according to claim 4, wherein the means for opening and closing said spout is arranged on the exterior of the spout, where said means for closing said spout comprises two substantially identical mirror image parts, where each part has a front plate and a back plate, where the front and back plates are contiguous, and where a closing lip is arranged along at least a part of the front plate, where said two parts are connected by a bridge member along a section of each side of the two parts, and where the spout of the bag may be accommodated between the two parts, and between the bridge parts along either side of the means for closing, and between the closing lips, and where the front plate is arranged at an angle relative to the back plate, such that as the back plates are forced towards each other the front plates will separate and allow material to pass through the spout, and further where biasing means may be provided urging the front plates together.

9. Method of manufacturing a flexible bag according to claim 1 from a flexible single or multilayered film material, where said bag has an asymmetric bottom where:
a. said material is shaped into a U-shaped cross section, such that two side portions and a bottom portion is created;
b. a former is introduced into the bottom portion of the U creating a W shape;
c. where the former is asymmetric, such that one V of the W is larger than the other V;
d. two seals are created at a mutual distance along the material, where said seals define the sides of the bag

10. Method according to claim 9, wherein the flexible film is sealable or weldable on only one side of the material, where said side is the side that will be the inside of the bag.
